(19) United States
(12) Patent Application Publication
(10) Pub. No.: US 2026/0271872 A1
(43) Pub. Date: Sep. 17, 2026

(54) METHOD AND DEVICE FOR CONTROLLING LITTER BOX, AND LITTER BOX

(71) Applicant: Ying Chen, Ningbo (CN)

(72) Inventor: Ying Chen, Ningbo (CN)

(21) Appl. No.: 19/676,545

(22) Filed: May 13, 2026

(51) Int. Cl. A01K 1/01

(52) U.S. Cl. CPC A01K 1/0114

(57) ABSTRACT

A method for controlling a litter box, a control device, and a litter box are provided. The method includes: driving a litter chamber to rotate in a first direction to separate litter from feces; upon reaching a preset condition, driving the chamber to rotate in an opposite second direction by a predetermined angle, causing the separated feces to mix and tumble with clean litter, thereby forming a moisture-absorbing litter coating on the feces before discharge. This full contact absorbs moisture, prevents sticking, reduces odor, and improves cleaning.

### TECHNICAL FIELD

The present disclosure relates to the field of smart home products, and more particularly, to a method for controlling a litter box, a control device, and a litter box.

### BACKGROUND

Smart litter boxes are widely used in the field of pet smart cleaning, for automatically separating, collecting and removing pet feces. A common rotary smart litter box typically includes a rotatable litter chamber, a litter sifting structure fixed within the litter chamber, a driving mechanism for rotating the litter chamber, and a collection bin for receiving feces. The working principle generally involves rotating the litter chamber in a single direction by the driving mechanism, using the sifting structure to separate litter from feces, and conveying the separated feces to a discharge outlet for automatic removal.

However, in existing control methods that rotate the litter chamber in a single direction, after the feces are separated and before they are discharged, the feces cannot sufficiently contact the clean litter within the litter chamber. As a result, moisture in the feces is not adequately absorbed, which tends to cause the feces to stick to the chamber wall or the sifting structure, and increases odor emission.

### SUMMARY

In one aspect, the present disclosure provides a method for controlling a litter box, comprising: driving a litter chamber of the litter box to rotate in a first rotational direction, so as to separate litter from feces; and in response to detecting that the litter chamber rotating in the first rotational direction has reached a preset trigger condition, driving the litter chamber to rotate in a second rotational direction opposite to the first rotational direction by a predetermined angle, so as to cause the litter within the litter chamber and the separated feces to mix and tumble.

In some embodiments, the driving a litter chamber of the litter box to rotate in a first rotational direction so as to separate litter from feces comprises: during the rotation, allowing loose litter to fall through gaps of a litter separating screen into a litter collection area, while retaining the feces on the litter separating screen.

In some embodiments, during the driving the litter chamber to rotate in the second rotational direction by the predetermined angle, the feces tumble from a surface of the litter separating screen in the second rotational direction into the litter at a bottom of the litter chamber, and during the tumbling, the feces are coated with litter on the surface thereof, thereby forming a litter coating layer on the surface of the feces for absorbing moisture.

In some embodiments, upon detecting that the litter chamber rotating in the first rotational direction has reached the preset trigger condition, the method further comprises: controlling the litter chamber to remain stationary for a preset duration, so as to allow the litter and the feces to fully contact and absorb moisture; and when the preset duration elapses, triggering the driving of the litter chamber to rotate in the second rotational direction by the predetermined angle.

In some embodiments, the preset trigger condition is that the litter chamber has rotated in the first rotational direction to a critical position where the feces have been separated but have not yet entered a discharge outlet.

In some embodiments, detecting that the litter chamber rotating in the first rotational direction has reached the preset trigger condition comprises: collecting a rotational position signal or a rotation duration of the litter chamber; and determining whether the litter chamber has reached the preset trigger condition based on a collected result.

In some embodiments, detecting that the litter chamber rotating in the first rotational direction has reached the preset trigger condition comprises: collecting a rotational angle signal of the litter chamber; and determining whether the litter chamber has reached the preset trigger condition based on the rotational angle signal.

In some embodiments, detecting that the litter chamber rotating in the first rotational direction has reached the preset trigger condition further comprises: driving the litter chamber to rotate to a mechanical limit position, and when the mechanical limit position is reached, calibrating that position as a reference zero point of a rotational angle of the litter chamber; recording a cumulative number of operation steps of a motor starting from the reference zero point; calculating a current rotational position of the litter chamber based on the reference zero point and the cumulative number of operation steps; and determining whether the litter chamber has reached the preset trigger condition based on the current rotational position.

In some embodiments, driving the litter chamber to rotate to the mechanical limit position comprises: collecting, in real time, an operating current of a driving motor that drives the litter chamber to rotate; detecting whether the operating current changes by a predetermined amplitude threshold compared to a previous sampling moment; and if so, determining that the litter chamber has reached the mechanical limit position.

In some embodiments, after the litter coating layer for absorbing moisture is formed on the surface of the feces, the method further comprises: driving the litter chamber to again rotate in the first rotational direction, so as to transfer the feces having the litter coating layer formed on the surface thereof to a collection bin via a discharge outlet.

In some embodiments, during the driving of the litter chamber to rotate in the second rotational direction by the predetermined angle to cause the litter and the separated feces to mix and tumble so as to form the litter coating layer, or after the litter coating layer is formed, the method further comprises: activating a vibration program to cause the litter in the litter chamber to vibrate and flow.

In another aspect, the present disclosure provides a control device for a litter box, comprising: a main control unit, and a motor driving unit electrically connected to the main control unit. The motor driving unit is configured to, in response to an instruction from the main control unit, drive a litter chamber of the litter box to rotate in a first rotational direction, so as to separate litter from feces. The main control unit is configured to, based on a fed-back rotational state signal of the litter chamber, send a second control instruction to the motor driving unit in response to detecting that the litter chamber rotating in the first rotational direction has reached a preset trigger condition. The motor driving unit is further configured to, in response to the second control instruction, drive the litter chamber to rotate in a second rotational direction opposite to the first rotational direction by a predetermined angle, so as to cause the litter within the litter chamber and the initially separated feces to mix and tumble.

In some embodiments, the motor driving unit is further configured to, during the rotation, allow loose litter to fall through gaps of a litter separating screen into a litter collection area, while retaining the feces on the litter separating screen.

In some embodiments, during the driving the litter chamber to rotate in the second rotational direction by the predetermined angle, the feces tumble from a surface of the litter separating screen in the second rotational direction into the litter at a bottom of the litter chamber, and during the tumbling, the feces are coated with litter on the surface thereof, thereby forming a litter coating layer on the surface of the feces for absorbing moisture.

In some embodiments, the main control unit is further configured to, after the litter coating layer is formed on the surface of the feces, control, via the motor driving unit, the litter chamber to remain stationary for a preset duration so as to allow the litter and the feces to fully contact; and, when the preset duration elapses, send the second control instruction to the motor driving unit to trigger the driving of the litter chamber to rotate in the second rotational direction by the predetermined angle.

In some embodiments, the motor driving unit is further configured to drive the litter chamber to rotate to a mechanical limit position; and the main control unit is further configured to: when the litter chamber reaches the mechanical limit position, calibrate that position as a reference zero point of a rotational angle of the litter chamber; calculate a current rotational position of the litter chamber based on the reference zero point and a collected cumulative number of operation steps of a motor starting from the reference zero point; and determine whether the litter chamber has reached the preset trigger condition based on the current rotational position.

In some embodiments, the control device further comprises a vibration driving unit electrically connected to the main control unit. The vibration driving unit is configured to, in response to an instruction from the main control unit, drive a vibration mechanism of the litter box to operate during the rotation of the litter chamber in the second rotational direction, or after the litter coating layer is formed and before the feces are discharged, so as to cause the litter within the litter chamber to vibrate and flow.

In yet another aspect, the present disclosure provides a litter box, comprising: a main housing, a litter chamber, a litter separating screen, a rotary driving mechanism, a main control circuit board, and a position detection element. The litter chamber is rotatably connected to the main housing. The litter separating screen is disposed on an inner side wall of the litter chamber and rotates synchronously with the litter chamber. A feces discharge outlet is formed at an edge of the side wall of the litter chamber where the litter separating screen is provided. A feces collection bin is arranged in the main housing below the feces discharge outlet, for collecting feces falling through the discharge outlet. The rotary driving mechanism is located inside the main housing and is in driving connection with the litter chamber, for driving the litter chamber to rotate in a first rotational direction or a second rotational direction. The position detection element is arranged corresponding to the litter chamber, for collecting a rotational state signal of the litter chamber. The main control circuit board is electrically connected to the rotary driving mechanism and the position detection element, respectively, and is configured to perform the method according to any one of the above-described embodiments.

With the method, control device and litter box provided by the embodiments of the present disclosure, the litter chamber is first driven to rotate in the first rotational direction to achieve initial separation of litter and feces, during which a small amount of litter preliminarily adheres to the surface of the feces. When it is detected that the litter chamber has rotated to the preset trigger condition, the litter chamber is driven to rotate in the second rotational direction opposite to the first rotational direction by the predetermined angle, so as to cause the litter within the litter chamber and the initially separated feces to mix and tumble again, thereby allowing the litter to fully coat the surface of the feces, so that moisture in the feces can be better absorbed before the feces are discharged from the litter chamber. Thus, the feces are effectively prevented from sticking to the chamber wall or the separating screen during discharge, odor emission is reduced, and the cleaning effect of the litter box is improved.

### BRIEF DESCRIPTION OF THE DRAWINGS

To more clearly illustrate the technical solutions in the embodiments of the present disclosure, the following briefly introduces the accompanying drawings required for describing the embodiments. Obviously, the drawings in the following description show only some embodiments of the present disclosure, and for those of ordinary skill in the art, other drawings can also be obtained from these drawings without any creative effort.

FIG. 1 is a schematic flow chart of a method for controlling a litter box according to an embodiment of the present disclosure.

FIG. 2 is a schematic flow chart of a method for controlling a litter box according to another embodiment of the present disclosure.

FIG. 3 is an exploded structural view of a litter box according to an embodiment of the present disclosure.

FIG. 4A is an assembled structural view of the litter box according to an embodiment of the present disclosure.

FIG. 4B is a front view of the litter box of FIG. 4A.

FIG. 4C is a cross-sectional view taken along line A-A of FIG. 4B.

FIGS. 5 to 10 are schematic views illustrating some embodiments of posture changes of the litter chamber during a feces cleaning process.

### DETAILED DESCRIPTION OF EMBODIMENTS

The technical solutions in the embodiments of the present disclosure will be described clearly and completely below with reference to the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without any creative effort fall within the protection scope of the present disclosure.

A smart litter box is a common automatic cleaning device in pet raising scenarios, capable of completing separation and discharge of litter and feces by rotating a chamber body in cooperation with a sifting structure. Currently, many rotary smart litter boxes on the market operate by rotating the litter chamber in a single direction: after the feces are sifted out by the separating screen, they are directly conveyed forward with the continuing rotation of the chamber body through the discharge outlet to the collection bin. However, in this single-direction rotation method for separating and cleaning feces, the contact time between the feces and litter is short, making it difficult for the feces to fully contact the clean litter in the chamber before being discharged, and the moisture in the feces cannot be well absorbed. Consequently, the feces tend to stick to the chamber wall.

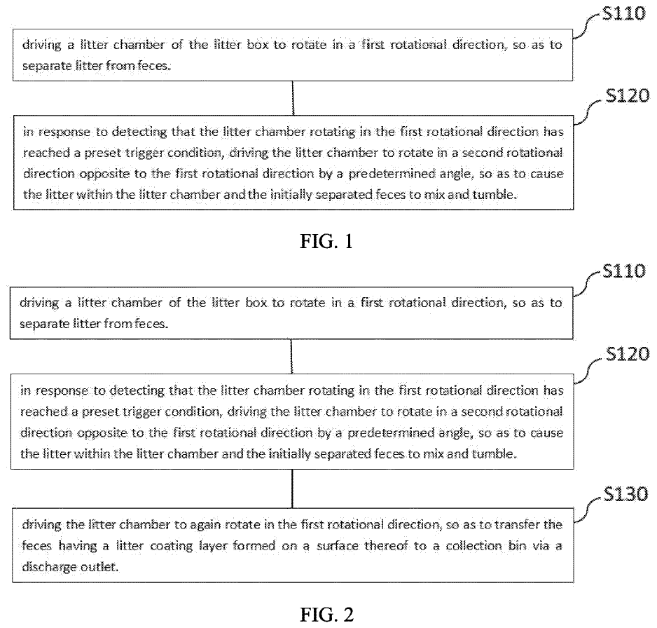

Referring to FIG. 1, an embodiment of the present disclosure provides a method for controlling a litter box, comprising:

S110, driving a litter chamber of the litter box to rotate in a first rotational direction, so as to separate litter from feces.

Specifically, a litter separating screen is fixedly arranged inside the litter chamber and can rotate synchronously with the litter chamber. The first rotational direction is a conventional rotation direction in which the litter box performs initial separation of litter and feces. When the litter chamber rotates in this direction, the litter and feces within the chamber continuously tumble under the rotational force, so that loose litter with smaller particle sizes can fall through gaps of the separating screen back to the bottom of the litter chamber, while the feces with larger particle sizes are blocked and supported by the separating screen and wrapped with at least some litter, and cannot pass through the screen, thereby completing the first separation and a preliminary sticking and wrapping of the feces.

S120, in response to detecting that the litter chamber rotating in the first rotational direction has reached a preset trigger condition, driving the litter chamber to rotate in a second rotational direction opposite to the first rotational direction by a predetermined angle, so as to cause the litter within the litter chamber and the initially separated feces to mix and tumble.

Specifically, the preset trigger condition is used to determine whether to activate the reverse rotation action of the litter chamber. The preset trigger condition may be any one of the litter chamber rotating to a specified position, a cumulative rotation duration reaching a set value, and a rotation angle reaching a preset value, or a combination of two or more of these conditions. The litter box may be correspondingly equipped with detection components for the corresponding trigger condition, so as to collect, in real time, state parameters such as rotational position, duration, and angle of the litter chamber, and determine, based on the set single condition or combination condition, whether the preset trigger condition for activating the reverse rotation action of the litter chamber is satisfied. When it is detected that the litter chamber satisfies the preset trigger condition, the litter chamber is controlled to switch to rotate in the reverse second rotational direction by the predetermined angle, and the feces supported on the separating screen will detach from the screen surface and fully mix and tumble with the clean litter in the litter chamber, so that the litter better wraps the outer surface of the feces, thereby forming the litter coating layer capable of absorbing moisture before the feces are discharged from the litter chamber.

In this embodiment, by controlling the litter chamber to first rotate in one direction to complete initial separation of litter and feces, during which a small amount of litter preliminarily wraps or sticks to the surface of the feces, and then rotating in reverse in another direction to achieve secondary wrapping by mixing the feces with litter, the feces can fully contact the clean litter in the litter chamber, so that moisture in the feces is better absorbed before the feces are discharged from the litter chamber. This effectively solves the existing problems of insufficient moisture absorption and easy sticking to the wall and odor emission of rotary litter boxes.

In some embodiments, step S110 may specifically comprise: during the rotation, allowing loose litter to fall through gaps of the litter separating screen into a litter collection area, while retaining the feces on the litter separating screen. The litter separating screen may be an arc-shaped grid structure or a mesh structure fixed inside the litter chamber. The size of the grid gaps or mesh holes is set to be larger than the particle size of the litter and smaller than the minimum size of the feces, so as to ensure effective separation of litter and feces. When the litter chamber rotates in the first rotational direction, the litter and feces in the chamber move toward the separating screen; the loose litter with smaller particle sizes can smoothly pass through the grid gaps and fall back to the litter collection area of the litter chamber to stay there. During the rotation in the first rotational direction, the surface of the feces will preliminarily stick to a small amount of litter, and be intercepted and supported on the surface of the separating screen by the grid; they may also move a certain distance toward the discharge outlet with the continued rotation of the litter chamber, thereby completing the initial separation of litter and feces.

In some embodiments, during the process of driving the litter chamber to rotate in the second rotational direction by the predetermined angle in step S120, the litter that has fallen into the litter collection area may flow back from the litter collection area to the bottom of the litter chamber through the gaps of the litter separating screen. At the same time, the feces tumble from the surface of the litter separating screen in the second rotational direction into the litter at the bottom of the litter chamber, and during the tumbling process, the feces are coated with litter on the surface thereof, forming the litter coating layer for absorbing moisture. Specifically, when the litter chamber rotates reversely in the second rotational direction, the feces originally intercepted and supported by the separating screen will detach from the surface of the separating screen under the reverse rotational force, and tumble back along the screen surface of the separating screen in the reverse direction. During this process, the separating screen can perform a second separation on the feces, sifting out the residual loose litter sticking to the surface of the feces, while making the feces fully mix with the clean litter at the bottom of the litter chamber. During the tumbling, the clean litter evenly attaches to the outer surface of the feces to form a complete moisture-absorbing coating layer, which not only improves litter utilization, but also improves the uniformity and sufficiency of the coating, so that the litter and feces contact better and absorb the moisture in the feces more sufficiently.

It is understandable that, according to the inventive concept of the present disclosure, in order to form solid matter that is easier to remove before the feces are discharged from the litter chamber, the driving program may be adjusted according to the moisture level of the feces, and the number of reciprocating rotations may be appropriately increased, so as to adapt to the moisture level of the feces, and prevent the feces from sticking to the chamber wall during discharge leading to incomplete cleaning, thereby improving the cleaning effect of the litter box.

To further improve the moisture absorption effect of the litter on the feces, in some embodiments, upon detecting that the litter chamber rotating in the first rotational direction meets the preset trigger condition, the method further comprises: controlling the litter chamber to remain stationary for a preset duration, so as to allow the litter and the feces to fully contact and absorb moisture; and when the preset duration elapses, triggering the driving of the litter chamber to rotate in the second rotational direction by the predetermined angle. The preset duration may be flexibly set according to actual conditions such as the type of litter and the moisture content of the feces, for example, it may be set to 3 to 10 seconds. During the stationary period, the feces intercepted by the separating screen can fully contact the clean litter remaining on the surface of the separating screen, absorbing part of the moisture and reducing the stickiness of the feces. When the stationary duration reaches the preset value, the litter chamber is triggered to rotate in the second rotational direction, so as to improve the overall moisture absorption effect and coating stability.

In some embodiments, the preset trigger condition is that the litter chamber has rotated in the first rotational direction to a critical position where the feces have completed the first separation but have not yet entered the discharge outlet. This critical position is a specific posture position of the litter chamber during rotation in the first rotational direction, at which the feces have been intercepted by the separating screen and completed the first separation, while still being at a distance from the discharge outlet and not yet having entered the conveying path to the discharge outlet. Using this position as the preset trigger condition can ensure that the feces will not be discharged prematurely when the reverse rotation action is initiated. The specific angle of this critical position can be adjusted according to parameters such as the size of the litter chamber and the installation position of the separating screen, and is not specifically limited in this embodiment.

In some embodiments, detecting whether the litter chamber has rotated in the first rotational direction to the preset trigger condition may be achieved by collecting a rotational position signal or a rotation duration of the litter chamber, and determining whether the litter chamber meets the preset trigger condition based on the collected result. For example, a real-time rotational position signal of the litter chamber can be collected by a position detection element, or a continuous rotation duration of the litter chamber can be collected by an internal timing module of the main control; the collected position data or duration data is compared with a preset threshold, and if either data reaches the preset value, it is determined that the trigger condition is met.

In some embodiments, it is also possible to collect a rotational angle signal of the litter chamber and determine whether the preset trigger condition is met based on the rotational angle signal. Illustratively, a photoelectric encoder, a potentiometer or an angle sensor may be used to collect the real-time rotational angle of the litter chamber, and the collected angle value is compared with a preset critical angle; if the angles match, it is determined that the preset trigger condition is met.

In some embodiments, detecting whether the litter chamber has reached the preset trigger condition may also be achieved by: driving the litter chamber to rotate to a mechanical limit position, and when the mechanical limit position is reached, calibrating that position as a reference zero point of a rotational angle of the litter chamber; recording a cumulative number of operation steps of a motor starting from the reference zero point; calculating a current rotational position of the litter chamber based on the reference zero point and the cumulative number of operation steps; and then determining whether the litter chamber has reached the preset trigger condition based on the current rotational position. The driving the litter chamber to rotate to the mechanical limit position may comprise: collecting, in real time, an operating current of a driving motor that drives the litter chamber to rotate; detecting whether the operating current changes by a predetermined amplitude threshold compared to a previous sampling moment; and if so, determining that the litter chamber has reached the mechanical limit position. In this example, when the litter chamber rotates to the mechanical limit position, the sudden increase in motor load will cause an abrupt change in current; therefore, by monitoring the abrupt change state of the current, the mechanical limit position can be determined. The collection of the operating current of the driving motor can be achieved by a Hall sensor, so as to accurately determine the time to start rotation in the second rotational direction.

Referring to FIG. 2, in some embodiments, after the litter coating layer for absorbing moisture is formed on the surface of the feces, the method further comprises:

S130, driving the litter chamber to again rotate in the first rotational direction, so as to transfer the feces having the litter coating layer formed on the surface thereof to a feces collection bin via a feces discharge outlet.

Specifically, after the litter coating layer is formed, the litter chamber is controlled to resume rotation in the first rotational direction, and the coated feces move toward the discharge outlet under the rotation, and finally fall into the feces collection bin. The coated feces have a substantially dry and non-sticky surface, neither sticking to the chamber wall nor to the screen, and can also greatly reduce odor emission, thus improving the cleanliness of the litter box. After the discharge of the feces is completed, the method may further comprise: driving the litter chamber to rotate to a preset posture angle to perform a leveling treatment on the litter in the chamber; the preset posture angle is generally about ±25°.

In some embodiments, during the process of driving the litter chamber to rotate in the second rotational direction to mix and tumble, or after the litter coating layer for absorbing moisture is formed on the surface of the feces, the method further comprises: activating a vibration program to cause the litter in the litter chamber to vibrate and flow. Illustratively, a vibration mechanism built in the litter box can drive the chamber body to vibrate at a low frequency, so that the litter more evenly wraps the feces, further improving the coating effect. Moreover, vibration can also prevent the litter from clumping, ensuring the flowability and use efficiency of the litter. The vibration mode can appear independently, or a vibration shaking action can be inserted during the rotation process.

The embodiments of the present disclosure also provide a control device for a litter box, comprising a main control unit and a motor driving unit electrically connected to the main control unit. The motor driving unit is configured to, in response to an instruction from the main control unit, drive a litter chamber of the litter box to rotate in a first rotational direction, so as to separate litter from feces. The main control unit is configured to, based on a fed-back rotational state signal of the litter chamber, send a second control instruction to the motor driving unit in response to detecting that the litter chamber rotating in the first rotational direction has reached a preset trigger condition. The motor driving unit is further configured to, in response to the second control instruction, drive the litter chamber to rotate in a second rotational direction opposite to the first rotational direction by a predetermined angle, so as to cause the litter within the litter chamber and the initially separated feces to mix and tumble.

With the control device provided in this embodiment, by driving the litter chamber to rotate in the first rotational direction to complete initial separation of litter and feces, during which a small amount of litter preliminarily adheres to the surface of the feces, and then, when it is detected that the litter chamber has rotated to the preset trigger condition, driving the litter chamber to rotate in the second rotational direction by the predetermined angle, the litter within the litter chamber and the feces, with some litter stuck to their surface after the initial separation, are caused to mix and tumble again to form the litter coating layer, so that the feces fully contact the litter, thus better absorbing moisture in the feces before they are discharged from the litter chamber, and improving the cleaning effect of the litter box.

In some embodiments, the process of driving the litter chamber of the litter box to rotate in the first rotational direction to separate litter from feces comprises: during the rotation, allowing loose litter to fall through gaps of a litter separating screen into a litter collection area, and retaining the feces on the litter separating screen. During the process of driving the litter chamber to rotate in the second rotational direction by the predetermined angle, the feces tumble from the surface of the litter separating screen in the second direction into the litter at the bottom of the litter chamber, and during the tumbling, the feces are coated with litter on the surface thereof, forming the litter coating layer for absorbing moisture.

In some embodiments, the main control unit is further configured to, after the litter coating layer is formed on the surface of the feces, control, via the motor driving unit, the litter chamber to remain stationary for a preset duration to allow the litter and the feces to fully contact; and when the preset duration elapses, send the second control instruction to the motor driving unit to trigger the driving of the litter chamber to rotate in the second rotational direction by the predetermined angle.

In some embodiments, the motor driving unit is further configured to drive the litter chamber to rotate to a mechanical limit position; and the main control unit is further configured to: when the litter chamber reaches the mechanical limit position, calibrate that position as a reference zero point of a rotational angle of the litter chamber; calculate a current rotational position of the litter chamber based on the reference zero point and a collected cumulative number of operation steps of a motor starting from the reference zero point; and then determine whether the litter chamber has reached the preset trigger condition based on the current rotational position.

In some embodiments, the control device further comprises a vibration driving unit electrically connected to the main control unit. The vibration driving unit is configured to, in response to an instruction from the main control unit, drive a vibration mechanism of the litter box to operate during the rotation of the litter chamber in the second rotational direction, or after the litter coating layer is formed and before the feces are discharged, so as to cause the litter within the litter chamber to vibrate and flow.

The above are exemplary embodiments of the control device for a litter box of the present disclosure. It should be noted that the technical solution of the control device for a litter box shares the same inventive concept as the technical solution of the foregoing method for controlling a litter box. For details not exhaustively described in the embodiments of the control device for a litter box, reference can be made to the description of the relevant embodiments of the method for controlling a litter box for understanding and implementation.

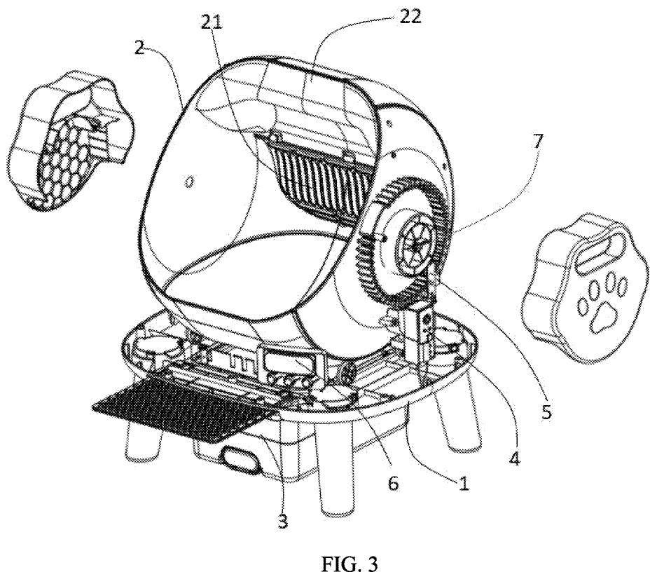

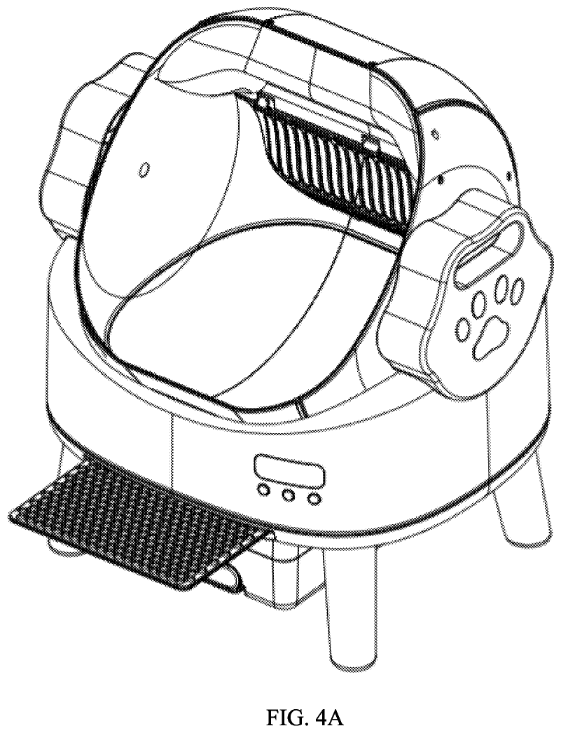

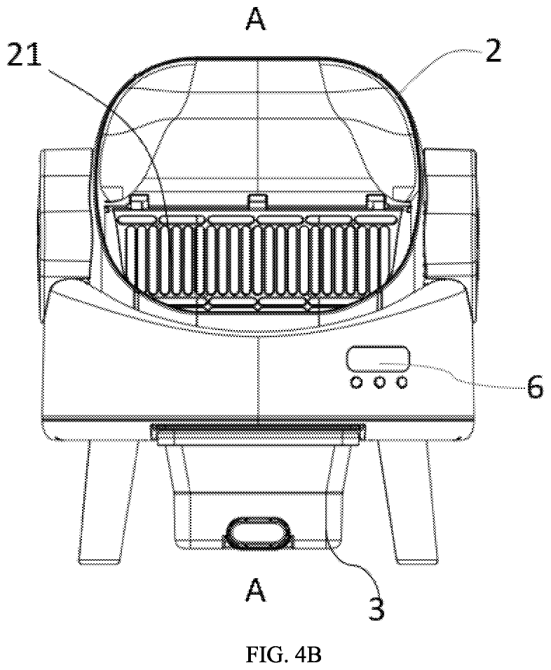

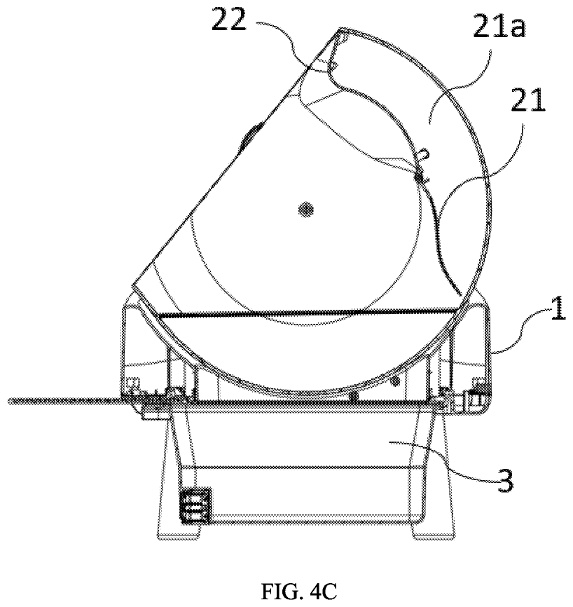

Referring to FIGS. 3, 4A, 4B, and 4C, in some embodiments, the present disclosure further provides a litter box, comprising: a main housing 1, a litter chamber 2, a litter separating screen 21, a feces discharge outlet 22, a feces collection bin 3, a rotary driving mechanism 4, a position detection element 5, and a main control circuit board 6. The litter chamber 2 is rotatably connected to the main housing 1. The litter separating screen 21 is disposed on an inner side wall of the litter chamber 2 and rotates synchronously with the litter chamber 2. The feces discharge outlet 22 is formed at an edge of the side wall of the litter chamber 2 where the litter separating screen 21 is provided. The feces collection bin 3 is arranged in the main housing 1 below the feces discharge outlet 22, for receiving feces falling through the discharge outlet. The rotary driving mechanism 4 is disposed inside the main housing 1 and is in driving connection with the litter chamber 2, for driving the litter chamber 2 to rotate in a first rotational direction or a second rotational direction. The position detection element 5 is arranged corresponding to the litter chamber 2, for collecting a rotational state signal of the litter chamber. The main control circuit board 6 is electrically connected to the rotary driving mechanism 4 and the position detection element 5, respectively, and is configured to perform the method for controlling a litter box described in any one of the foregoing embodiments.

It is understandable that the litter box in this embodiment also includes many other components, but to highlight the inventive points of the present disclosure, these other specific components are not reiterated here.

To more clearly describe the working process of this litter box, the following describes the workflow of an application example of the embodiment of the present disclosure in combination with the postures of the litter chamber during the rotation process shown in FIGS. 3, 4B, 4C, and 5 to 10:

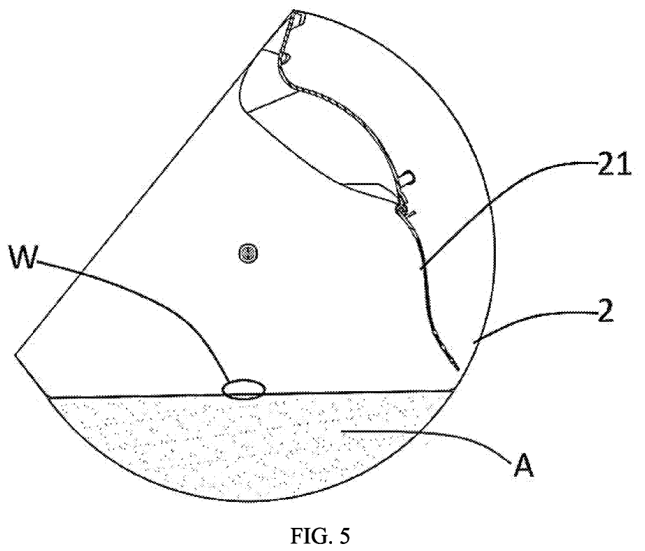

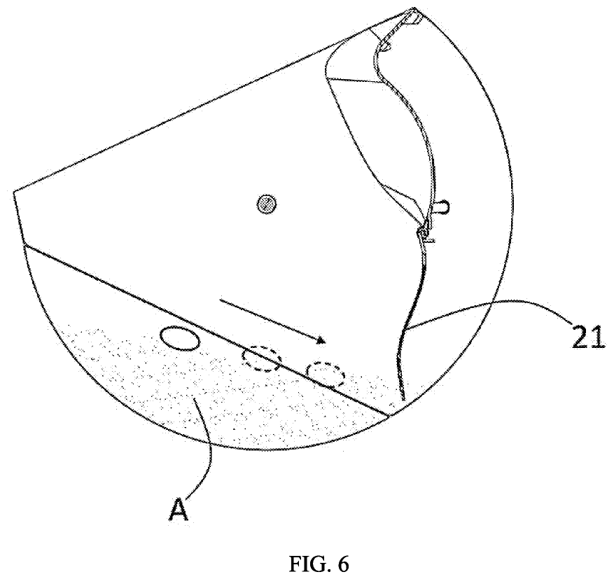

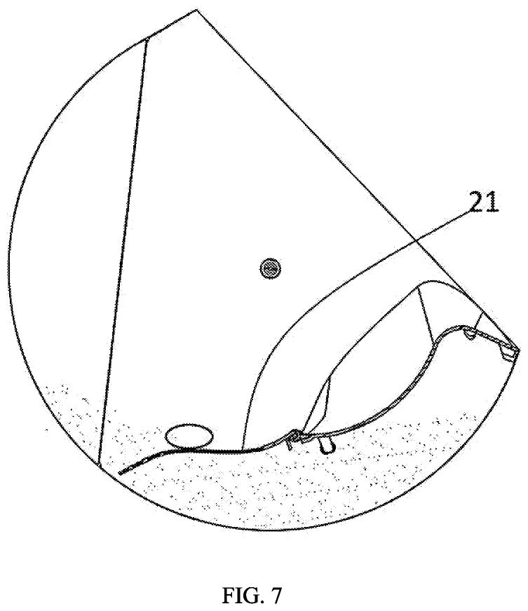

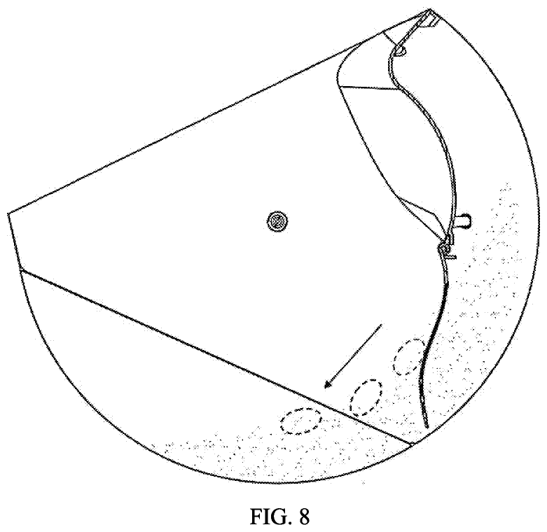

After a cat finishes defecating and leaves the litter box, the litter chamber 2 is in the initial static posture shown in FIG. 5. An infrared sensor 7 detects that the cat has left the litter box, and sends a signal to the main control circuit board 6. The main control circuit board 6 controls the rotary driving mechanism 4 to start, driving the litter chamber 2 to rotate in the first rotational direction. The litter A and feces W flow along with the litter chamber, and the flow direction is as shown by the arrows in FIG. 6. When the litter chamber rotates in the first rotational direction to a certain position, the litter A and feces W are in the process of first separation, as shown in FIG. 7. During this process, loose litter falls through the gaps of the litter separating screen 21 into a litter collection area 21a of the litter chamber 2 corresponding to the separating screen, and the feces W are intercepted and retained on the litter separating screen 21, completing the first separation.

Then, the main control circuit board 6 collects the rotational angle or duration signal of the litter chamber 2 via the position detection element 5, or determines the mechanical limit position based on the motor current detected by a Hall sensor, calibrates this mechanical limit position as the reference zero point of the rotation angle, and calculates the real-time position of the litter chamber 2 in combination with the cumulative number of operation steps of the motor, or determines, based on the duration signal or the like, that the litter chamber 2 has satisfied the preset trigger condition. At this time, the main control circuit board 6 controls the litter chamber 2 to remain stationary for a preset duration, allowing the feces and litter to preliminarily contact and absorb moisture. When the preset duration elapses, it sends an instruction to drive the litter chamber 2 to rotate reversely in the second rotational direction by a predetermined angle, as shown in FIG. 8.

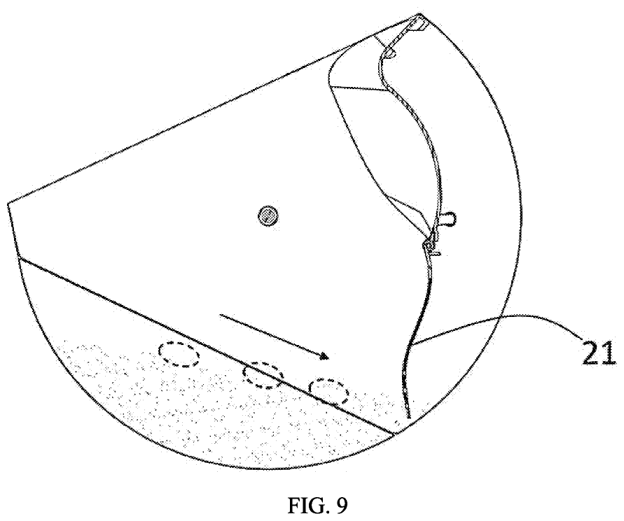

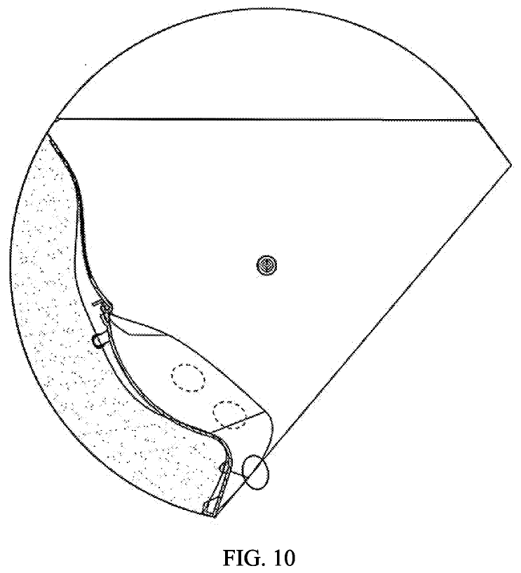

During the reverse rotation mixing and tumbling process, or after the litter coating layer is formed and before the feces are discharged, the main control circuit board 6 may also control the vibration driving mechanism to start, driving the litter in the litter chamber 2 to vibrate and flow, so that the feces and clean litter fully mix, forming the litter coating layer for absorbing moisture on the surface of the feces. After the coating is completed, referring to FIG. 9, the main control circuit board 6 controls the litter chamber 2 to rotate in the first rotational direction again, to the dumping posture illustrated in FIG. 10 (it should be noted that, since the action of the litter box is a dynamic process, this illustration is only a schematic to help understand the solution of this embodiment, and cannot be understood as an actual corresponding working position), transferring the feces with the coating layer formed on the surface thereof to the feces collection bin 3 via the feces discharge outlet 22. After the feces are discharged, the litter chamber 2 may optionally be driven to rotate to the leveling posture shown in FIG. 5, to level the remaining litter in the chamber and then return to the initial posture, completing the entire cleaning process.

In the working process of the litter box, the litter chamber is driven to rotate in the first rotational direction to complete initial separation of litter and feces, during which a small amount of litter preliminarily adheres to the surface of the feces. When it is detected that the litter chamber has rotated to the preset trigger condition, the litter chamber is driven to rotate in the second rotational direction opposite to the first rotational direction by the predetermined angle, causing the litter within the litter chamber and the initially separated feces wrapped with a layer of litter to mix and tumble again, forming the litter coating layer for absorbing moisture, thereby achieving full contact between the feces and the litter in the litter chamber, and better absorbing moisture in the feces before they are discharged from the litter chamber, so as to improve the cleaning effect.

It should be noted that, in this text, relational terms such as first and second are merely used to distinguish one entity or operation from another entity or operation, and do not necessarily require or imply any such actual relationship or order between these entities or operations. Moreover, the terms “comprise,” “include” or any other variants thereof are intended to cover non-exclusive inclusion, so that a process, method, article or device comprising a series of elements includes not only those elements, but also other elements not explicitly listed, or also includes elements inherent to such process, method, article or device.

Although the embodiments of the present disclosure have been shown and described, for those of ordinary skill in the art, it is understandable that various changes, modifications, substitutions and variations may be made to these embodiments without departing from the principles and spirit of the present disclosure, and the scope of the present disclosure is defined by the appended claims and their equivalents.

What is claimed is:

1. A method for controlling a litter box, comprising:
driving a litter chamber of the litter box to rotate in a first rotational direction, so as to separate litter from feces; and
in response to detecting that the litter chamber rotating in the first rotational direction has reached a preset trigger condition, driving the litter chamber to rotate in a second rotational direction opposite to the first rotational direction by a predetermined angle, so as to cause the litter within the litter chamber and the separated feces to mix and tumble.

2. The method of claim 1, wherein the driving a litter chamber of the litter box to rotate in a first rotational direction so as to separate litter from feces comprises:
during the rotation, allowing loose litter to fall through gaps of a litter separating screen into a litter collection area, while retaining the feces on the litter separating screen.

3. The method of claim 2, wherein, during the driving the litter chamber to rotate in the second rotational direction by the predetermined angle, the feces tumble from a surface of the litter separating screen in the second rotational direction into the litter at a bottom of the litter chamber, and during the tumbling, the feces are coated with litter on the surface thereof, thereby forming a litter coating layer on the surface of the feces for absorbing moisture.

4. The method of claim 1, wherein, upon detecting that the litter chamber rotating in the first rotational direction has reached the preset trigger condition, the method further comprises:
controlling the litter chamber to remain stationary for a preset duration, so as to allow the litter and the feces to fully contact and absorb moisture; and
when the preset duration elapses, triggering the driving of the litter chamber to rotate in the second rotational direction by the predetermined angle.

5. The method of claim 4, wherein the preset trigger condition is that the litter chamber has rotated in the first rotational direction to a critical position where the feces have been separated but have not yet entered a discharge outlet.

6. The method of claim 1, wherein detecting that the litter chamber rotating in the first rotational direction has reached the preset trigger condition comprises:
collecting a rotational position signal or a rotation duration of the litter chamber; and
determining whether the litter chamber has reached the preset trigger condition based on a collected result.

7. The method of claim 1, wherein detecting that the litter chamber rotating in the first rotational direction has reached the preset trigger condition comprises:
collecting a rotational angle signal of the litter chamber; and
determining whether the litter chamber has reached the preset trigger condition based on the rotational angle signal.

8. The method of claim 1, wherein detecting that the litter chamber rotating in the first rotational direction has reached the preset trigger condition further comprises:
driving the litter chamber to rotate to a mechanical limit position, and when the mechanical limit position is reached, calibrating that position as a reference zero point of a rotational angle of the litter chamber;
recording a cumulative number of operation steps of a motor starting from the reference zero point;
calculating a current rotational position of the litter chamber based on the reference zero point and the cumulative number of operation steps; and
determining whether the litter chamber has reached the preset trigger condition based on the current rotational position.

9. The method of claim 8, wherein driving the litter chamber to rotate to the mechanical limit position comprises:
collecting, in real time, an operating current of a driving motor that drives the litter chamber to rotate;
detecting whether the operating current changes by a predetermined amplitude threshold compared to a previous sampling moment; and
if so, determining that the litter chamber has reached the mechanical limit position.

10. The method of claim 3, wherein, after the litter coating layer for absorbing moisture is formed on the surface of the feces, the method further comprises:
driving the litter chamber to again rotate in the first rotational direction, so as to transfer the feces having the litter coating layer formed on the surface thereof to a collection bin via a discharge outlet.

11. The method of claim 3, wherein, during the driving of the litter chamber to rotate in the second rotational direction by the predetermined angle to cause the litter and the separated feces to mix and tumble so as to form the litter coating layer, or after the litter coating layer is formed, the method further comprises:
activating a vibration program to cause the litter in the litter chamber to vibrate and flow.

12. A control device for a litter box, comprising:
a main control unit; and
a motor driving unit electrically connected to the main control unit;
wherein the motor driving unit is configured to, in response to an instruction from the main control unit, drive a litter chamber of the litter box to rotate in a first rotational direction, so as to separate litter from feces;
wherein the main control unit is configured to, based on a fed-back rotational state signal of the litter chamber, send a second control instruction to the motor driving unit in response to detecting that the litter chamber rotating in the first rotational direction has reached a preset trigger condition; and
wherein the motor driving unit is further configured to, in response to the second control instruction, drive the litter chamber to rotate in a second rotational direction opposite to the first rotational direction by a predetermined angle, so as to cause the litter within the litter chamber and the initially separated feces to mix and tumble.

13. The control device of claim 12, wherein the motor driving unit is further configured to, during the rotation, allow loose litter to fall through gaps of a litter separating screen into a litter collection area, while retaining the feces on the litter separating screen.

14. The control device of claim 13, wherein, during the driving the litter chamber to rotate in the second rotational direction by the predetermined angle, the feces tumble from a surface of the litter separating screen in the second rotational direction into the litter at a bottom of the litter chamber, and during the tumbling, the feces are coated with litter on the surface thereof, thereby forming a litter coating layer on the surface of the feces for absorbing moisture.

15. The control device of claim 14, wherein the main control unit is further configured to, after the litter coating layer is formed on the surface of the feces, control, via the motor driving unit, the litter chamber to remain stationary for a preset duration, so as to allow the litter and the feces to fully contact; and, when the preset duration elapses, send the second control instruction to the motor driving unit to trigger the driving of the litter chamber to rotate in the second rotational direction by the predetermined angle.

16. The control device of claim 12, wherein:
the motor driving unit is further configured to drive the litter chamber to rotate to a mechanical limit position; and
the main control unit is further configured to:
when the litter chamber reaches the mechanical limit position, calibrate that position as a reference zero point of a rotational angle of the litter chamber;
calculate a current rotational position of the litter chamber based on the reference zero point and a collected cumulative number of operation steps of a motor starting from the reference zero point; and
determine whether the litter chamber has reached the preset trigger condition based on the current rotational position.

17. The control device of claim 12, further comprising a vibration driving unit electrically connected to the main control unit;
wherein the vibration driving unit is configured to, in response to an instruction from the main control unit, drive a vibration mechanism of the litter box to operate during the rotation of the litter chamber in the second rotational direction, or after a litter coating layer is formed and before the feces are discharged, so as to cause the litter within the litter chamber to vibrate and flow.

18. A litter box, comprising:
a main housing;
a litter chamber rotatably connected to the main housing;
a litter separating screen disposed on an inner side wall of the litter chamber and rotating synchronously with the litter chamber;
a rotary driving mechanism located inside the main housing and in driving connection with the litter chamber, the rotary driving mechanism being configured to drive the litter chamber to rotate in a first rotational direction or a second rotational direction;
a main control circuit board; and
a position detection element;
wherein a feces discharge outlet is formed at an edge of the side wall of the litter chamber where the litter separating screen is provided, and a feces collection bin is arranged in the main housing below the feces discharge outlet, for collecting feces falling through the discharge outlet;
wherein the position detection element is arranged corresponding to the litter chamber, for collecting a rotational state signal of the litter chamber; and
wherein the main control circuit board is electrically connected to the rotary driving mechanism and the position detection element, respectively, and is configured to perform the method of claim 1.
